(19) United States
(12) Patent Application Publication
(10) Pub. No.: US 2016/0085867 A1
(43) Pub. Date: Mar. 24, 2016

(54) METHOD AND SYSTEM FOR AGGREGATING OPINIONS

(71) Applicants: Richard Gomez, Dublin, CA (US); Paul C Ling, Pleasanton, CA (US); Lorraine Ling, Pleasanton, CA (US)

(72) Inventors: Richard Gomez, Dublin, CA (US); Paul C Ling, Pleasanton, CA (US); Lorraine Ling, Pleasanton, CA (US)

(21) Appl. No.: 14/863,664

(22) Filed: Sep. 24, 2015

Related U.S. Application Data
(60) Provisional application No. 62/054,526, filed on Sep. 24, 2014.

(51) Int. Cl. G06F 17/30

(52) U.S. Cl. CPC G06F 17/30867

(57) ABSTRACT

A computer implemented method of and system for aggregating opinions corresponding to an organization are disclosed. According to the method, a plurality of opinions from a plurality of data sources may be received using a processor. Each data source of the plurality of data sources may include one or more opinions corresponding to the organization. Subsequently, two or more opinions of the plurality of opinions may be determined, using a processor, to be corresponding to the organization based on presence of one or more identifiers associated with the organization in each of the two or more opinions. Further, the two or more opinions may be presented, using a processor, to a user.

### CROSS REFERENCE TO RELATED APPLICATIONS

The present application claims benefit of U.S. Provisional Patent Application No. 62/054,526, filed Sep. 24, 2014, the disclosure of which is incorporated herein by reference in its entirety.

### FIELD

The disclosure generally relates to data processing. More specifically, the disclosure relates to method and system for aggregating opinions corresponding to an organization.

### BACKGROUND

The World Wide Web (WWW) has become an important source of information for users in general. One reason for the widespread use of online resources is the ease of accessibility. Information may be conveniently searched through search engines in order to retrieve required information. Moreover, due to the large number of information sources available online, a huge amount of information is readily available to users. As a result, users are increasingly relying on online sources for their everyday needs.

One common use of online resources by users is for accessing opinions about entities such as individuals, organizations, products and services. Such opinions may be valuable to users, for example, who may be considering purchasing a product or availing a service. Usually, opinions about an entity may be available at an online source associated with the entity. For example, opinions about an organization may be available a website of the organization. Further, opinions about the entity may be available at an online source dedicated for providing opinions. However, there are several such online sources for providing opinions about entities. As a result, opinions about an entity provided by different users are scattered across multiple online sources. Consequently, users are unable to conveniently access the opinions about the entity in a comprehensive manner.

Therefore, there is a need for methods and systems for aggregating opinions from multiple online sources.

### SUMMARY

Disclosed is a computer implemented method of aggregating opinions corresponding to an organization. The method may include receiving, with a processor, a plurality of opinions from a plurality of data sources. Each data source of the plurality of data sources may include one or more opinions corresponding to the organization. Further, the method may include determining, with a processor, at least two opinions of the plurality of opinions as corresponding to the organization based on presence of at least one identifier associated with the organization in each of the at least two opinions. Furthermore, the method may include presenting, with a processor, the at least two opinions to a user.

Also disclosed is a system for aggregating opinions corresponding to an organization. The system may include a processor configured for receiving a plurality of opinions from a plurality of data sources. Each data source of the plurality of data sources may include one or more opinions corresponding to the organization. The processor may be further configured for determining at least two opinions of the plurality of opinions as corresponding to the organization based on presence of at least one identifier associated with the organization in each of the at least two opinions. Further, the processor may also be configured for presenting the at least two opinions to a user.

### BRIEF DESCRIPTION OF DRAWINGS

FIG. 1 illustrates a method of aggregating opinions corresponding to an organization in accordance with an embodiment.

FIG. 2 illustrates a method of aggregating opinions corresponding to an organization in accordance with another embodiment.

FIG. 3 illustrates a system for aggregating opinions corresponding to an organization in accordance with an embodiment.

FIG. 4 illustrates a system for aggregating opinions corresponding to an organization in accordance with another embodiment.

### DETAILED DESCRIPTION

Overview

The present disclosure relates to methods and systems for aggregating opinions from a plurality of data sources. In an instance, the opinions may correspond to an entity such as, for example, but not limited to, an individual, an organization, a product and a service. The plurality of data sources may be, but are not limited to, online sources such as, for example, websites dedicated for provisioning opinions. Examples of such websites may include YeIp™, Google+™, Glassdoor™, TripAdvisor™, ConsumerReports™, Amazon customer reviews™, TrustPilot™ etc.

In an instance, opinions corresponding to the entity may be received from users. However, a first opinion corresponding to the entity present in a first data source of the plurality of data sources may be different from a second opinion corresponding to the entity present in a second data source of the plurality of data sources. For example, the first opinion may be received from a first user while the second opinion may be received from a second user.

When a user wishes to access opinions corresponding to the entity such as, for example, an organization, each of the first opinion and the second opinion may be retrieved from corresponding data sources. Subsequently, each of the first opinion and the second opinion may be analysed in order to detect presence of a common identifier. The common identifier may be, for example, but is not limited to, a name, a location and a telephone number. Based on the presence of the common identifier, each of the first opinion and the second opinion may be determined as corresponding to the entity. For example, based on the presence of a common telephone number in each of the first opinion and the second opinion, it may be determined that each of the first opinion and the second opinion are about the entity. Subsequently, each of the first opinion and the second opinion may be presented to the user in an aggregated form such as, for example, a single webpage. As a result, the user may be able to access each of the first opinion and the second opinion in a comprehensive manner.

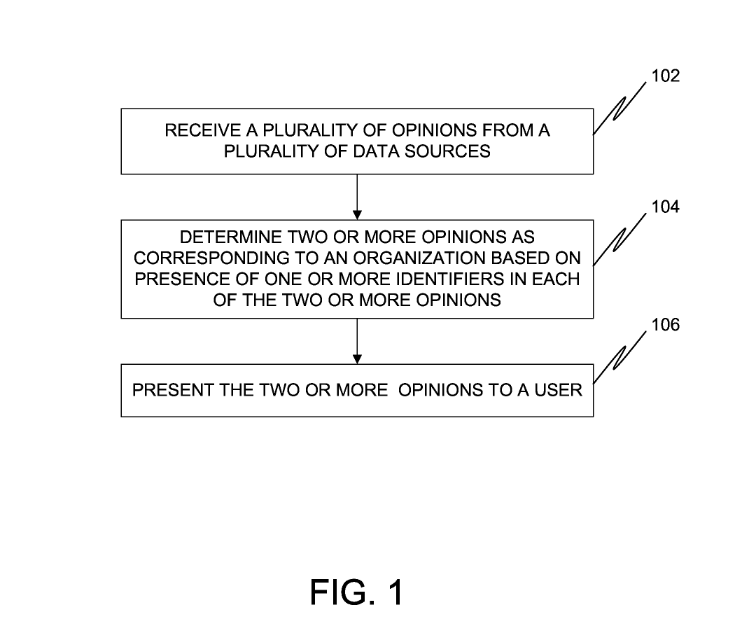

FIG. 1 illustrates a flow chart of a method of aggregating opinions corresponding to an organization in accordance with an embodiment. The opinions may be received from, for example, users who may have interacted with the organization. For instance, the organization may be a company selling a product and the users who bought the product may provide opinions about the organization. The opinions may include one or more of a review and a rating. The rating may be one or more of a quantitative rating and a qualitative rating. For example, the rating may be a value within a predetermined range such as 1 to 10 provided by a user in order to represent the user's opinion about the organization in a quantitative manner. In an instance, a higher value of rating may represent a more favourable opinion as compared to a lower value rating. As another example, the rating may be a qualitative rating such as “Good”, “Satisfactory”, “Poor” etc. The review may be an opinion that may be descriptive. For example, the review provided by a user about the organization may be descriptive of one or more aspects of the organization. For instance, the review may include an explanation by the user justifying a rating provided by the user. In general, the opinions may be expressed in one or more forms such as, but not limited to, numbers, text, glyph, images, audio, video and multimedia.

In an instance, the opinions may be stored in a plurality of data sources such as, but not limited to, local databases, online databases and websites. For example, a data source of the plurality of data sources may be a website specially configured for receiving and presenting opinions. Accordingly, the website may include a user interface configured for receiving an opinion corresponding to the organization from a user. Further, the website may also include a user interface configured for searching opinions based on one or more search criteria such as, but not limited to, name of an organization, name of an individual, name of a product/service, an age of an opinion etc. Further, the website may include a user interface for presenting results of the searching.

At step 102, a plurality of opinions may be received from the plurality of data sources using a processor. Each data source of the plurality of data sources may include one or more opinions corresponding to the organization. In an instance, the plurality of opinions may be provided by different users. In other words, a first opinion of the plurality of opinions may be provided by a first user while a second opinion of the plurality of opinions may be provided by a second user different from the first user. Moreover, the first opinion may be present in a first data source of the plurality of data sources while the second opinion may be present in a second data source of the plurality of data sources. For example, the first user may have provided the first opinion on YeIp™, while the second user may have provided the second opinion on Google+™. In other words, each of the first opinion and the second opinion are spread across multiple data sources.

Accordingly, in an embodiment, the plurality of opinions may be retrieved from the plurality of data sources. In an instance, the retrieving may include transmitting an Application Programming Interface (API) request to one or more data sources of the plurality of data sources. Accordingly, the one or more data sources may be configured for receiving the API request and providing a response. The API request may be of a predetermined format including an ordered arrangement of variable values. For example, the API request may include values corresponding to, for example, one or more of name of the organization, a location of the organization, a telephone number of the organization, demographic data of users who provided the plurality of opinions, age of an opinion of the plurality of opinions, number of votes corresponding to an opinion, keywords present in an opinion, a rating corresponding to an opinion, a format of an opinion, a media-type of an opinion such as audio, video, text etc., a size of an opinion such as number of words, duration of video review etc. and any other characteristic of an opinion.

In another embodiment, the retrieving may include crawling one or more websites corresponding to the plurality of data sources. For example, a website crawler may automatically access multiple pages of the one or more websites and create copy of the plurality of opinions present on the one or more websites. Further, the website crawler may also create an index corresponding to the one or more websites. As a result, users may be able to perform electronic searching within the plurality of opinions based on the index.

Furthermore, subsequent to retrieving, the plurality of opinions may be processed in order to obtain a predetermined form of the plurality of opinions. For instance, the first opinion available from the first data source may be of a format different from that of the second opinion available from the second data source. In an embodiment, each of the plurality of opinions may be processed in order to obtain a common format across the plurality of opinions. For example, the first opinion may be in the form of a video while the second opinion may be in the form of text. Accordingly, the first opinion may be processed to obtain a textual form of the first opinion. In some embodiments, processing of the plurality of opinions may include one or more operations such as, but not limited to, filtering, summarising, translating, transcribing and annotating the plurality of opinions.

At step 104, two or more opinions of the plurality of opinions may be determined, using a processor, to be corresponding to the organization based on presence of one or more identifiers associated with the organization in each of the two or more opinions. In an embodiment, the one or more identifiers may include one or more of, but not limited to, the name of the organization, a location of the organization and a telephone number of the organization. In general, the one or more identifiers associated with the organization may be such that the organization may be differentiated from other organizations having identifiers different from the one or more identifiers. In an instance, the one or more identifiers may uniquely identify the organization. For example, a telephone number associated with the organization may uniquely identify the organization. In another instance, the one or more identifiers may identify a plurality of organizations including the organization. For example, each of the plurality of organizations may be associated with a common identifier such as a location.

The one or more identifiers associated with the organization may be included in an opinion of the plurality of opinions. For example, a user providing a review of the organization may mention one or more of the name of the organization, an address of the organization and a telephone number of the organization. In another instance, the user may provide a review of a product corresponding to the organization. Based on a predetermined association between the product and the organization, information corresponding to the organization such as the name of the organization, a name of a representative of the organization, a location of the organization and a telephone number of the organization may be automatically included in the opinion. In some embodiments, the one or more identifiers may be included in the opinion in the form of metadata. For instance, an opinion of the plurality of opinions may have a structure including field variables corresponding to one or more of the name of the organization, the location of the organization and the telephone number of the organization. In another embodiment, the one or more identifiers may be included in the opinion in an unstructured manner. For example, the one or more identifiers may appear within the opinion as part of natural language description provided users. Accordingly, the opinion may be processed in order to extract the one or more identifiers.

As an example, consider the first opinion retrieved from the first data source and the second opinion retrieved from the second data source as an instance of the two or more opinions. Each of the first opinion and the second opinion may be about the organization. In an instance, the first opinion may include the name of the organization and the telephone number of the organization while the second opinion may include only the name of the organization. Accordingly, based on the presence of a common identifier such as the name of the organization, each of the first opinion and the second opinion may be determined to be associated with the organization. In other words, each of the first opinion and the second opinion may be identified as different opinions about the same entity such as the organization. In another instance, the first opinion may include a name of a product associated with the organization while the second opinion may include the name of the organization. Accordingly, each of the name of the product and the name of the organization may be an instance of the one or more identifiers. Based on the presence of the name of the product and the name of the organization in the first opinion and the second opinion respectively, each of the first opinion and the second opinion may be determined to be opinions about the same entity such as the organization.

Subsequently, at step 106, the two or more opinions determined to be corresponding to the organization may be presented, using a processor, to a user. In an embodiment, the two or more opinions corresponding to the organization may be displayed through a single user interface such as for example, but not limited to, a single website. In another embodiment, the two or more opinions may be displayed on a single webpage corresponding to the organization. In yet another embodiment, an opinion of the two or more opinions corresponding to a data source of the plurality of data sources may be displayed separately from another opinion of the two or more opinions corresponding to another data source of the plurality of data sources. For example, a first data source of the plurality of data sources may include a first plurality of opinions of the two or more opinions while a second data source of the plurality of data sources may include a second plurality of opinions of the two or more opinions. Accordingly, the first plurality of opinions may be displayed together as a first group of opinions while the second plurality of opinions may be displayed together as a second group of opinions. As a result, a user may be presented with an aggregated view of the two or more opinions while also providing a user-friendly indication of the plurality of data sources corresponding to the two or more opinions. For example, a first section of the website may display the first plurality of opinions from the first data source such as YeIp™ while a second section of the website may display the second plurality of opinions from the second data source such as Google+™. As another example, a first plurality of ratings included in the first plurality of opinions may be aggregated to obtain a first average rating while a second plurality of ratings included in the second plurality of opinions may be aggregated to obtain a second average rating. The first average rating may represent an average opinion of a first community of users corresponding to the first data source such as, for example, YeIp™. Similarly, the second average rating may represent an average opinion of a second community of users corresponding to the second data source such as, for example, Google+™. Consequently, users may be able to conveniently view average opinions corresponding to multiple data sources at a glance. In a further embodiment, each of the two or more opinions may be presented together in an aggregated view independent of corresponding data sources. For instance, each of the first plurality of opinions from the first data source such as YeIp™ and the second plurality of opinions from the second data source such as Google+™ may be displayed together in a common section of the website. As an example, each of the first average rating and the second average rating may be aggregated to obtain a combined average rating for the organization. In some embodiments, in addition to presenting the two or more opinions, additional information corresponding to the organization may also be presented. For example, a map displaying the location of the organization may be presented along with the two or more opinions.

In other embodiments, the two or more opinions may be presented to users through one or more presentation devices corresponding to one or more sensory modalities such as, but not limited to, visual modality, auditory modality and tactile modality. As a result of presenting the two or more opinions retrieved from the plurality of data sources, users may be provided with a comprehensive view of opinions corresponding to an entity such as the organization.

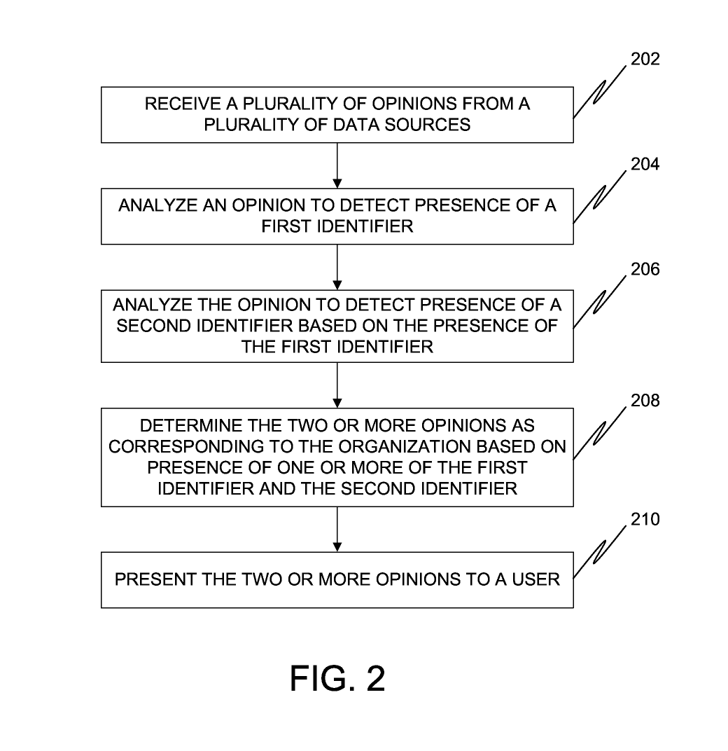

FIG. 2 illustrates a method of aggregating opinions corresponding to the organization in accordance with another embodiment. At step 202, the plurality of opinions may be received, using a processor, from the plurality of data sources. Further, each data source of the plurality of data sources may include one or more opinions corresponding to the organization. Details regarding step 202 may be understood from description of step 102 explained in conjunction with FIG. 1. Subsequently, at step 204, an opinion of the two or more opinions may be analyzed, using a processor, in order to detect presence of a first identifier of the one or more identifiers in the opinion. For example, the opinion may be analyzed in order to detect presence of the telephone number associated with the organization. Thereafter, at step 206, based on the presence of the first identifier, the opinion may be further analyzed in order to detect presence of a second identifier of the one or more identifiers. In an instance, if the first identifier such as, for example, the telephone number of the organization, is absent in the opinion, the opinion may be analyzed to detect presence of the second identifier such as, for example, an address of the organization. In another instance, if the first identifier such as, for example, the telephone number of the organization, is present in the opinion, the opinion may not be analyzed to detect presence of the second identifier such as, for example, an address of the organization. In yet another instance, the opinion may be analyzed to detect presence of each of the first identifier and the second identifier independent of presence of either the first identifier or the second identifier in the opinion.

Subsequently, at step 208, the two or more opinions may be determined, using a processor, to be corresponding to the organization based on presence of one or more of the first identifier and the second identifier in the two or more opinions. For instance, upon detecting the presence of the first identifier such as, for example, the telephone number of the organization in each of the two or the more opinions, it may be determined that the two or more opinions correspond to the organization. Thereafter, at step 210, the two or more opinions may be presented to a user. Details regarding step 210 may be understood from description of step 106 explained in conjunction with FIG. 1.

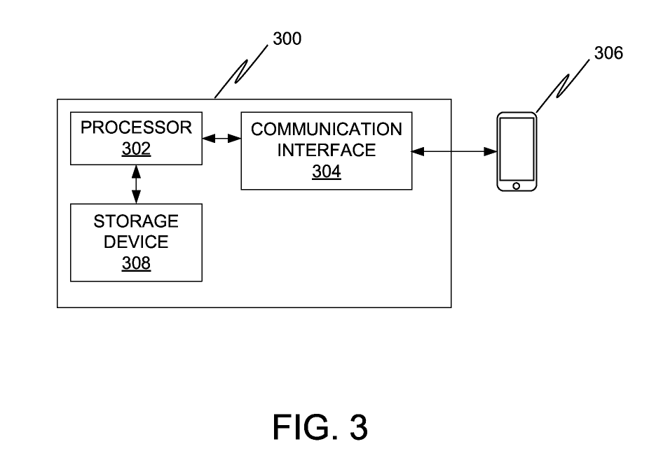

FIG. 3 illustrates a system 300 for aggregating opinions corresponding to the organization in accordance with an embodiment. The system 300 may include a processor 302 configured for receiving the plurality of opinions from the plurality of data sources. Each data source of the plurality of data sources may include the one or more opinions corresponding to the organization. Further, the processor 302 may be configured for determining the two or more opinions of the plurality of opinions as corresponding to the organization based on presence of the one or more identifiers associated with the organization in each of the two or more opinions. Furthermore, the processor 302 may also be configured for presenting the two or more opinions to a user. In an embodiment, one or more presentation devices such as, but not limited to, display devices, speakers and Braille displays may be used for presenting the two or more opinions.

In an instance, the system 300 may be a server computer configured for communicating with one or more client computers such as, but not limited to, desktop computers, laptop computers, tablet computers and smart-phones. Accordingly, the system 300 may include a communication interface 304 configured for communicating with the one or more client computers such as client computer 306. Further, the server may be configured for receiving a request from the one or more client computers for presenting aggregated opinions corresponding to the organization. For example, a user of a client device such as a smart-phone may wish to know the opinions of users about a restaurant. Accordingly, based on a selection of the restaurant by the user, the request may be transmitted to the server computer. The server computer may be configured for aggregating the plurality of opinions corresponding to the organization such as the restaurant. In an embodiment, the server computer may be configured for performing the aggregating of the plurality of opinions, as described in conjunction with FIG. 1 and FIG. 2, prior to receiving the request for aggregated opinions. In another embodiment, the server computer may be configured for performing the aggregating of the plurality of opinions, as described in conjunction with FIG. 1 and FIG. 2, after receiving the request for aggregated opinions.

In another embodiment, the system 300 may be configured for aggregating the plurality of opinions corresponding to the organization and transmitting an aggregated opinion to one or more client computers. For example, the system 300 may be configured for aggregating the plurality of opinions, as described in detail in conjunction with FIG. 1 and FIG. 2, and store the plurality of opinions in a server database that may be subsequently synchronized with local databases located on the one or more client computers. Accordingly, the system 300 may include a storage device 308 configured for storing information such as, but not limited to, the plurality of opinions. As a result, users of the one or more client computers may be able to retrieve and view aggregated opinions of an entity such as the organization as per their needs.

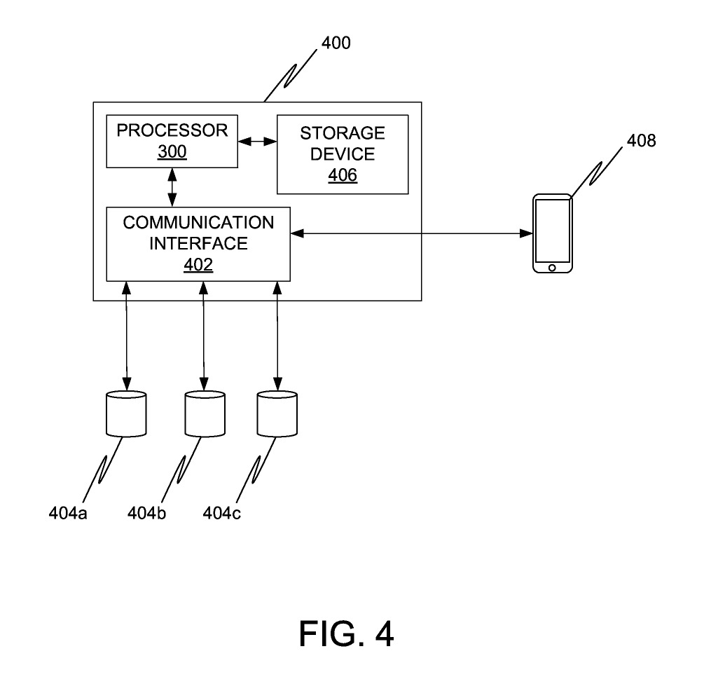

FIG. 4 illustrates a system 400 for aggregating opinions corresponding to the organization in accordance with another embodiment. The system 400 may include the processor 300 configured for performing the steps described in detail in conjunction with FIG. 1 and FIG. 2. Further, the system 400 may include a communication interface 402 configured for communicating with the plurality of data sources 404 as exemplarily illustrated as data source 404a, 404b and 404c. For instance, the system 400 may be a server computer configured to communicate with the plurality of data sources 404 over a computer network such as the Internet. Accordingly, the communication interface 402 may be configured for generating requests and receiving responses compatible with the plurality of data sources. For example, the communication interface 402 may be configured for generating the API requests corresponding to the plurality of opinions. Further, the communication interface 402 may also be configured for retrieving the plurality of opinions from the plurality of data sources. In some embodiments, the communication interface may be configured for communicating with a local data source located in a storage device 406. For example, the system 400 may be configured for crawling websites corresponding to the plurality of data sources and creating the index. Further, the storage device 406 may be configured for storing the index. Moreover, the communication interface 402 may be configured for communicating with one or more client computers such as client computer 408. Accordingly, the communication interface 402 may be configured for receiving requests from the one or more client computers for aggregated opinions and transmitting responses including the plurality of opinions in an aggregated form to the one or more client computers. As a result, users of the one or more client computers may be provided with aggregated opinions corresponding to an entity such as the organization.

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In an embodiment, the invention may be implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Furthermore, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

While the present invention has been described in the foregoing embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

We claim:

1. A computer implemented method of aggregating opinions corresponding to an organization, the method comprising:
receiving, with a processor, a plurality of opinions from a plurality of data sources, wherein each data source of the plurality of data sources comprises at least one opinion corresponding to the organization;
determining, with a processor, at least two opinions of the plurality of opinions as corresponding to the organization based on presence of at least one identifier associated with the organization in each of the at least two opinions;
presenting, with a processor, the at least two opinions to a user.

2. The computer implemented method of claim 1, wherein the at least one identifier comprises at least one of a name, a location and a telephone number.

3. The computer implemented method of claim 1, wherein an opinion of the at least two opinions comprises at least one of a review and a rating.

4. The computer implemented method of claim 1 further comprising retrieving, with a processor, the plurality of opinions from the plurality of data sources.

5. The computer implemented method of claim 4, wherein the retrieving comprises transmitting an Application Programming Interface (API) request to at least one data source of the plurality of data sources.

6. The computer implemented method of claim 4, wherein the retrieving comprises crawling at least one website corresponding to the plurality of data sources.

7. The computer implemented method of claim 1, wherein the presenting comprises displaying the at least two opinions on a single website.

8. The computer implemented method of claim 7, wherein two or more opinions of the at least two opinions corresponding to a data source of the plurality of data sources are displayed in a group.

9. The computer implemented method of claim 1, wherein a first data source of the plurality of data sources is based on a first format and a second data source of the plurality of data sources is based on a second format, wherein the second format is different from the first format.

10. The computer implemented method of claim 1, wherein the determining the at least two opinions as corresponding to the organization comprises:
analyzing, with a processor, an opinion of the at least two opinions in order to detect presence of a first identifier of the at least one identifier in the opinion; and
analyzing, with a processor, the opinion of the at least two opinions in order to detect presence of a second identifier of the at least one identifier in the opinion based on the presence of the first identifier.

11. A system for aggregating opinions corresponding to an organization, the system comprising a processor configured for:
receiving a plurality of opinions from a plurality of data sources, wherein each data source of the plurality of data sources comprises at least one opinion corresponding to the organization;
determining at least two opinions of the plurality of opinions as corresponding to the organization based on presence of at least one identifier associated with the organization in each of the at least two opinions;
presenting the at least two opinions to a user.

12. The system of claim 11, wherein the at least one identifier comprises at least one of a name, a location and a telephone number.

13. The system of claim 11, wherein an opinion of the at least two opinions comprises at least one of a review and a rating.

14. The system of claim 11, wherein the processor is further configured for retrieving the plurality of opinions from the plurality of data sources.

15. The system of claim 14, wherein the retrieving comprises transmitting an Application Programming Interface (API) request to at least one data source of the plurality of data sources.

16. The system of claim 14, wherein the retrieving comprises crawling at least one website corresponding to the plurality of data sources.

17. The system of claim 11, wherein the presenting comprises displaying the at least two opinions on a single website.

18. The system of claim 17, wherein two or more opinions of the at least two opinions corresponding to a data source of the plurality of data sources are displayed in a group.

19. The system of claim 11, wherein a first data source of the plurality of data sources is based on a first format and a second data source of the plurality of data sources is based on a second format, wherein the second format is different from the first format.

20. The system of claim 11, wherein the determining the at least two opinions as corresponding to the organization comprises:
analyzing an opinion of the at least two opinions in order to detect presence of a first identifier of the at least one identifier in the opinion; and
analyzing the opinion of the at least two opinions in order to detect presence of a second identifier of the at least one identifier in the opinion based on the presence of the first identifier.
